(19) United States
(12) Patent Application Publication
(10) Pub. No.: US 2009/0033667 A1
(43) Pub. Date: Feb. 5, 2009

(54) Method and Apparatus to Facilitate Depicting an Object in Combination with an Accessory

(75) Inventors: Shuang Xu, Algonquin, IL (US); Timothy James Collins, Homer Glen, IL (US)

Correspondence Address: MOTOROLA/FETF, 120 S. LASALLE STREET, SUITE 1600, CHICAGO, IL, 60603-3406, US

(73) Assignee: Motorola, Inc., Schaumburg, IL (US)

(21) Appl. No.: 11/832,965

(22) Filed: Aug. 2, 2007

(51) Int. Cl. G06T 5/00; G06T 15/70

(52) U.S. Cl. 345/474

(57) ABSTRACT

At a personally portable wireless two-way communicator (800), one can provide (101) an avatar as corresponds to a given object and then capture (102) an image as corresponds to an accessory for that given object. That image can be used (103) to determine corresponding metadata for the accessory which metadata is then used (104) to determine a virtual visual rendering of the accessory. One can then visually display (105) the avatar in combination with the virtual visual rendering of the accessory to thereby provide an image that depicts how the given object and the accessory will appear in combination with one another.

### TECHNICAL FIELD

This invention relates generally to portable communications devices and more particularly to virtual renderings using a portable communications device.

### BACKGROUND

The prior art is replete with objects of various kinds. These objects range greatly in size, purpose, shape, function, and so forth and include both living and inanimate objects. Many such objects can be viewed as comprising accessories for other objects. For example, when a given object comprises a human being, exemplary accessories might comprise any of a wide variety of clothing articles. For a variety of reasons it can be important to match a given accessory to a given corresponding object in a manner that complies with one or more criteria regarding acceptability. These criteria can vary with respect to, for example, physical requirements, societal requirements, and personal preferences, to note but a few examples in this regard.

As a result, though one or more accessories may be useful or even critical for a given object, locating and vetting a given accessory for a given object can become a time-consuming (at best) or personally vexing and objectionable (at worst) activity. As but one simple illustrative example in this regard, many people find shopping for clothing to be an unfulfilling or even an unpleasant expenditure of time and attention. This can hold true regardless of whether the person is shopping for their own clothing or are shopping for the clothing of another (such as a significant other).

In many cases, shopping comprises a largely physical, real world activity when viewed from start to finish. In particular, even when shopping on-line or from a hardcopy catalog, a looming question in the shopper's mind is, “Will this fit?” or “How will this look when worn?” By one prior art approach, an in-store kiosk-like facility serves to virtually cloak a mirrored image of the shopper with a virtual rendering of a garment in question in order to provide the shopper with some information regarding the answer to such questions. Such facilities, while satisfactory to some, nevertheless remain objectionable to a large body of potential shoppers due, for example, to the requisite need to visit the store itself in order to take advantage of such a service.

### BRIEF DESCRIPTION OF THE DRAWINGS

The above needs are at least partially met through provision of the method and apparatus to facilitate depicting an object in combination with an accessory described in the following detailed description, particularly when studied in conjunction with the drawings, wherein:

FIG. 1 comprises a flow diagram as configured in accordance with various embodiments of the invention;

FIG. 2 comprises a schematic representation as configured in accordance with various embodiments of the invention;

FIG. 3 comprises a flow diagram as configured in accordance with various embodiments of the invention;

FIG. 4 comprises a front elevational schematic representation as configured in accordance with various embodiments of the invention;

FIG. 5 comprises a block diagram as configured in accordance with various embodiments of the invention;

FIG. 6 comprises a schematic representation as configured in accordance with various embodiments of the invention;

FIG. 7 comprises a schematic representation as configured in accordance with various embodiments of the invention; and

FIG. 8 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, at a personally portable wireless two-way communicator, one can provide an avatar as corresponds to a given object and then capture an image as corresponds to an accessory for that given object. That image can be used to determine corresponding metadata for the accessory which metadata is then used to determine a virtual visual rendering of the accessory. One can then visually display the avatar in combination with the virtual visual rendering of the accessory to thereby provide an image that depicts how the given object and the accessory will appear in combination with one another.

By one approach, as when the given object comprises a particular human being, this avatar can comprise a virtual rendering of at least a portion of that human being (such as an above-the-waist view of that human being). For many purposes it will be useful for this avatar to be proportionally substantially identical to the human being and for this avatar to include the face of that particular human being as well.

By one approach, the object's captured image can comprise an optical code which comprises, or leads to, in turn the aforementioned metadata. When the accessory comprises, for example, clothing, this metadata can include information regarding various relevant dimensions of the article of clothing, external patterns, textures, or the like, and so forth. In such an illustrative case, then, the step of presenting a combination of both the object with the accessory can comprise showing a proportionally accurate rendering of the article of clothing as worn by this particular person. In other words, the composite rendering comprises a view of how this particular person would appear upon donning this particular item of clothing. This, in turn, can permit a viewer to make informed decisions regarding the fit of the clothing as well as the aesthetic appearance thereof or the suitability of such clothing for a desired purpose.

So configured, these teachings will readily permit a person of interest to shop for accessories for a wide variety of objects, including themselves or other persons of interest, without necessitating a visit to a retail establishment or the like. Those skilled in the art will understand and appreciate that these teachings offer a highly flexible approach that can be leveraged in a variety of ways to accommodate a wide set of differing application circumstances. It will also be recognized that these teachings are readily scaled and will accommodate a wide variety of objects, accessories, and the like. It will further be appreciated that these teachings can be readily implemented using a considerable variety of existing infrastructures and platforms and thus offers an efficient and economical approach to address the expressed concerns.

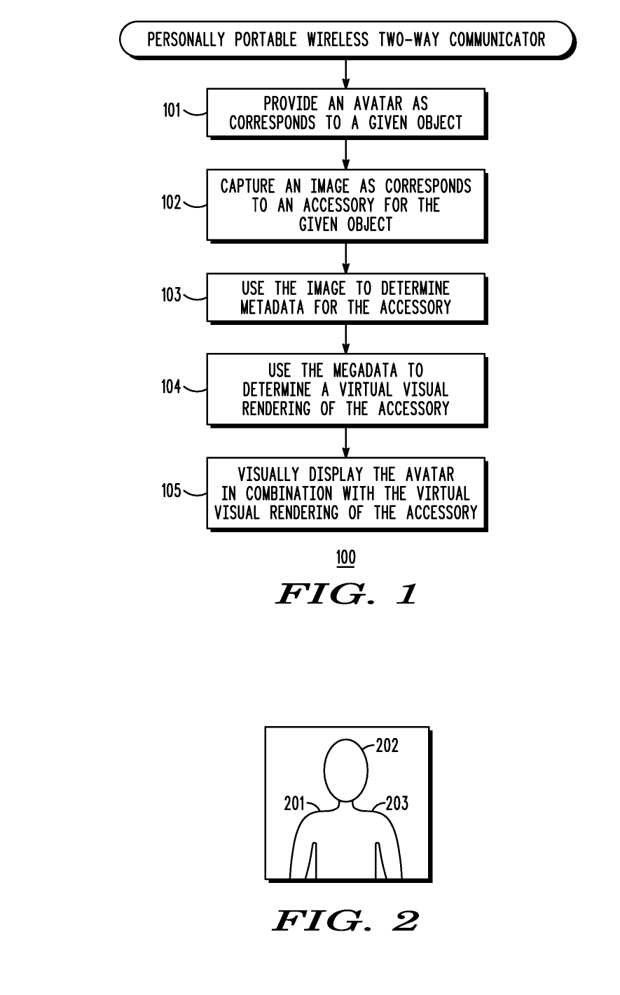

These and other benefits may become clearer upon making a thorough review and study of the following detailed description. Referring now to the drawings and in particular to FIG. 1, an illustrative process 100 as comports with these teachings will be presented. This process 100 can be implemented using, for example, a personally portable wireless two-way communicator such as, but not limited to, a cellular telephone or the like. Further illustrative details regarding a platform suitable for use with such a process 100 will be presented below.

This process 100 provides for provision 101 of an avatar as corresponds to a given object. For the purposes of explanation and example, a significant portion of this description will presume that this given object comprises a human being. Those skilled in the art will understand and appreciate, however, that such an example is not intended as a limitation and that the object may in fact comprise any number of other objects.

When this given object comprises a human being, by one approach the provided avatar will itself assume the form factor of a human being as well. For many application settings it will further be desirable that this avatar be proportionally substantially identical to the particular human being to which it corresponds.

As one example in this regard, and referring momentarily to FIG. 2, this avatar 201 can have a facial area 202 and a corresponding body 203. The body portion 203 can comprise only a torso section (as illustrated), a full-body view, or some other section of choice. There are various ways by which such an avatar 201 can be provided. For example, by one approach, this process 100 will accommodate capturing an image of a given human being and then providing a face for the facial area 202 of the avatar 201 through use of that image of the human being.

There are also various ways to provide for the aforementioned dimensionally accurate proportions of the avatar's body. By one approach, for example, this process 100 will accommodate receiving input from, say, a user of the personally portable wireless two-way communicator regarding various external dimensions of the user. Examples in this regard might include, but are not limited to, shoulder measurements, neck measurements, chest measurements, waist measurements, and so forth. Such information can be entered using, for example, a questionnaire-style information entry mechanism with other possibilities existing as well. These external measurements of the user can then be used to determine an appearance of the avatar that graphically represents the user.

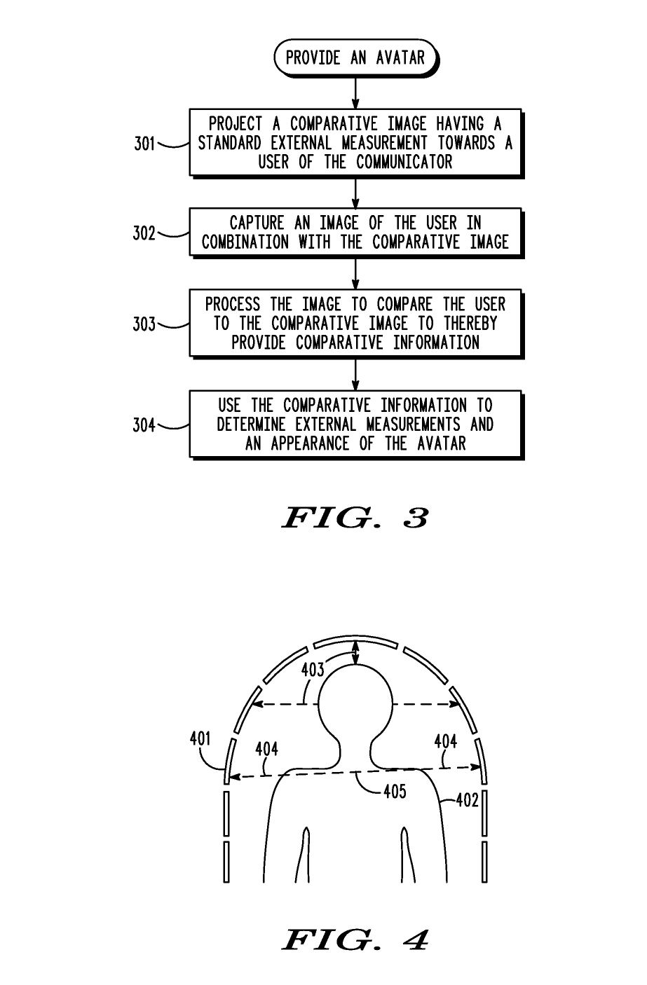

As noted, there are various ways by which a given user's dimensions are determined to facilitate the provision of the aforementioned avatar. Referring now momentarily to FIGS. 3 and 4, another approach will be considered. This approach can be used in combination with the aforesaid information entry approach or in lieu thereof.

Pursuant to this process, one projects 301 a comparative image 401 that has a standard external measurement towards a user 402 of the personally portable wireless two-way communicator through use of a comparative image projector. When the comparative image projector is located a known distance from a given display surface (such as a blank wall or screen), the comparative image 401 will have known dimensions that can then be compared and contrasted with respect to the user 402. Upon then capturing 302 an image of the user 402 in combination with this comparative image 401, this process 300 then provides for processing 303 that image to compare the user 402 to the comparative image 401 to thereby provide comparative information.

The particular comparative information so developed can vary with respect to the needs and/or opportunities afforded in a given application setting. Illustrative examples include, but are certainly not limited to, distances 403 between selected portions of the comparative image 401 and the user's head, distances 404 between the comparative image 401 and the user's shoulders, and so forth. This process 300 can then provide for using 304 this comparative information to determine external measurements of interest as correspond to the user 402. As but one illustrative example in this regard, this could comprise a shoulder-to-shoulder dimension 405 for this user 402. Accordingly, these external measurements can then be applied with respect to informing the appearance of the aforementioned avatar.

Referring again to FIG. 1, this step of providing 101 an avatar can correspond to providing an avatar of a user of the aforementioned personally portable wireless two-way communicator. These teachings will also accommodate, however, providing an avatar of a third party to the user of the personally portable wireless two-way communicator. This third person might comprise, for example, a significant other, a child, a clothing consultant client, and so forth (with many other examples being possible).

By one approach, for example, this step of providing 101 an avatar for a third party can comprise, at least in part, receiving a wireless transmission of information that defines, at least in part, the avatar for that third person. By one approach, such information can be provided in a substantially unprotected state. By another approach, however, this avatar information can comprise encrypted information. The personally portable wireless two-way communicator can then be configured and arranged to make use of that encrypted information in a manner such that a user of that personally portable wireless two-way communicator cannot themselves glean the third party avatar information itself in unencrypted form. By this approach, the personally portable wireless two-way communicator can make use of the resultant decrypted avatar while nevertheless denying the user access to directly view the corresponding measurements that yield that avatar, thereby preserving a measure of privacy for the corresponding third party.

This process 100 then provides for capturing 102 an image as corresponds to an accessory for the given object. By one approach, the personally portable wireless two-way communicator comprises an image capture device such as a digital camera. Such a camera can be readily employed to achieve this step as will be well understood by those skilled in the art.

For any given object, a wide range of accessories may be considered in this regard. For the sake of the present illustrative example, it will be presumed that this accessory comprises an article of clothing that may be worn by the human being in question. Again, those skilled in the art will understand and appreciate that this use of clothing serves an illustrative purpose and is not intended to suggest any particular limitations in this regard.

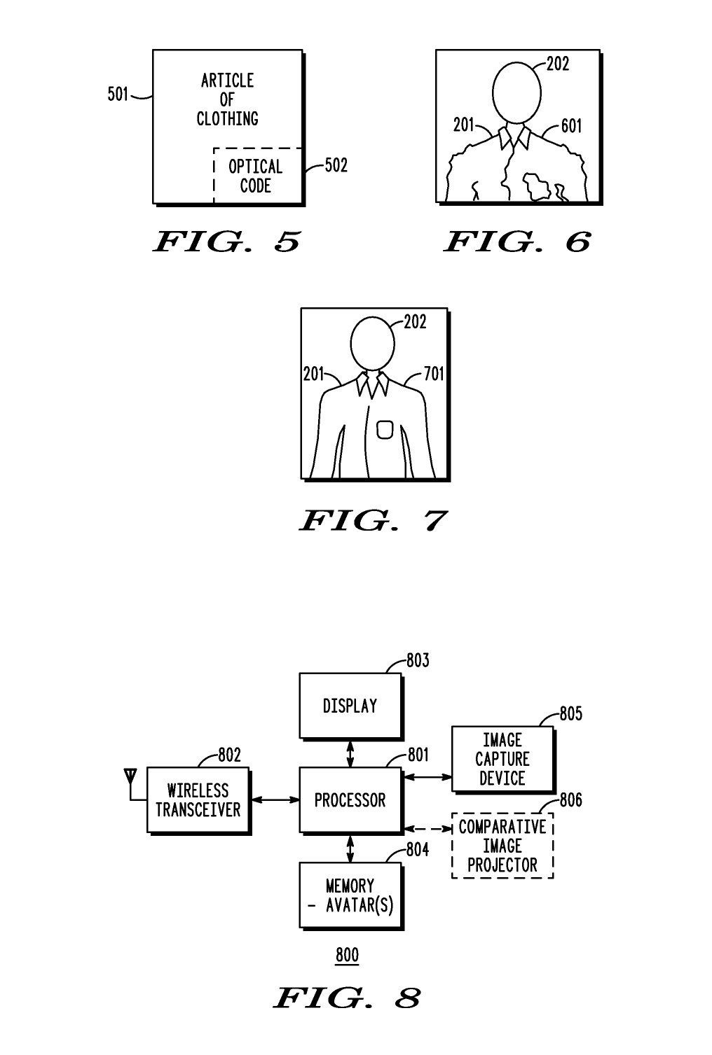

By one approach, this captured image can comprise an image of the article of clothing itself. These teachings will also accommodate, however, capturing an image comprising an optical code. With momentary reference to FIG. 5, for example, a given article of clothing 501 can include a permanently or temporarily affixed optical code 502 that can be so captured. It would also be possible for such a code to be located proximal to a display of such articles of clothing though not necessarily on the clothing items themselves. Various optical codes are known in the art, including one dimensional codes (such as the ubiquitous bar code), two dimensional codes, and so forth.

This process 100 then provides for using 103 that image to determine metadata for the accessory. This metadata can vary with respect to the accessory itself. When the accessory comprises an article of clothing, examples of possibly useful metadata might include, but are not limited to, at least one linear measurement, information regarding color, information regarding an external pattern, information regarding an external texture, information regarding a size of at least a portion of the accessory, information regarding how the article of clothing tends to conform, or not conform, to the human shape, information regarding how the article of clothing tends to hang or drape when worn, information regarding to what extent the article of clothing tends to change its size over time (due, for example, to repeated washings), and so forth, to note but a few examples in this regard.

Such informational content might be directly included in the metadata itself. It would also be possible for the metadata to comprise an address that the personally portable wireless two-way communicator might contact in order to receive the information that describes the accessory. By yet another approach, as when the captured image simply comprises a view of the article of clothing itself, the personally portable wireless two-way communicator may transmit that image to a remote resource that (with or without human assistance and intervention) identifies the accessory using a recognition process and then returns the corresponding characterizing information to the personally portable wireless two-way communicator.

This process 100 then uses 104 that metadata to form a virtual visual rendering of that accessory. This leads, in turn, to visually displaying 105 the avatar in combination with the virtual visual rendering of the accessory to thereby provide an image that depicts how the given object and the accessory will appear in combination with one another. As the avatar comprises a dimensionally accurate representation of the object, and as the metadata permits a dimensionally accurate representation of the accessory, this visual rendering need not comprise an idealized or generic representation of such a combination. Instead, to a significant extent, this rendering can serve to illustrate how, in fact and in real life, this particular accessory will appear in combination with this particular object.

To illustrate, and referring now to FIG. 6, when the accessory comprises an article of clothing that is sized to large for the person in question, this visual rendering will depict the clothing item 601 as indeed being too large on the avatar 201. So configured, and without requiring the person in question to actually try the article of clothing on for size, a viewer is able to immediately determine that the article of clothing that is of present interest is sized too large for this particular person.

Referring now to FIG. 7, by repeating the described process for this same article of clothing, albeit in a smaller size, the viewer will see instead an article of clothing 701 that properly fits the avatar 201. As the avatar dimensionally corresponds to the proposed wearer of this particular garment, a viewer can then make a purchasing decision regarding this garment knowing that the article of clothing will likely fit in a desired manner.

Such a representation can serve other purposes as well, of course. In addition to judging fit, such an approach will permit a viewer to understand how this particular person will look in this particular color or style of clothing. These teachings will also accommodate permitting the viewer to zoom in or to zoom out to thereby afford differing views that can facilitate making a desired examination. These teachings will further support, if desired, rotating the avatar or otherwise permitting other perspectives and views of the avatar in combination with the article of clothing to thereby glean a more complete understanding of how the object and accessory appear with one another. It would also be possible to support an animated view of the avatar walking, sitting, running, or engaging in some other activity of interest while wearing the article of clothing, if desired.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 8, an illustrative approach to such a platform will now be provided.

In this illustrative example, the personally portable wireless two-way communicator 800 comprises a cellular telephone. Skilled artisans will know that other two-way devices as are presently known or which may be developed hereafter will likely also serve well in these regards. Here, the personally portable wireless two-way communicator 800 comprises, generally speaking, a processor 801 that operably couples to a wireless transceiver 802, a display 803 (such as a monochromatic or full color display of choice), a memory 804 (which serves to store, for example, one or more of the aforementioned avatars), and an image capture device 805 such as a digital camera. If desired, the processor 801 can also optionally operably couple to a comparative image projector 806 (such as a laser-based projection system) by which the aforementioned comparative image can be projected as described above). Such architectural components are generally well understood in the art and require no further elaboration here.

The processor 801 can comprise a fixed-purpose platform or a partially or wholly programmable platform. Such architectural choices are also well understood in the art and require no further discussion here. This processor 801 can be configured and arranged (for example, by corresponding programming) to carry out one or more of the steps, activities, or functions described herein. This can comprise, for example, capturing an image (via the image capture device 805) as corresponds to an accessory for a given object and then using that image to determine the aforementioned metadata for that accessory. This can also comprise using the metadata to determine a virtual visual rendering of the accessory and then visually displaying (via the display 803) the avatar in combination with the virtual visual rendering of the accessory to thereby provide an image that depicts how the given object and the accessory will appear in combination with one another.

Such an apparatus can further comprise, for example, a user input interface to thereby facilitate receiving input from a user of the personally portable wireless two-way communicator 800 regarding external measurements of, for example, that user. In such a case, the processor 801 can be further configured and arranged to use those external measurements to determine an appearance of the avatar that serves to graphically represent that user.

Those skilled in the art will recognize and understand that such an apparatus 800 may be comprised of a plurality of physically distinct elements as is suggested by the illustration shown in FIG. 8. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize and appreciate that such an apparatus can be used and leveraged in a wide variety of ways. As a first example in this regard, a given user can use these teachings while shopping in a retail establishment to test various garments for size and the like while avoiding the need to actually physically try on such clothing. As a second example in this regard, a user can utilize an avatar for a significant other to determine whether a particular item of clothing will in fact suitably fit that significant other prior to purchasing the item and presenting it to that person. As a third example in this regard, a clothing consultant can transmit selected accessory information to a client's personally portable wireless two-way communicator. Upon receipt, the accessory information can be used as described to present a suitably clothed model avatar by which the recipient client can make a determination regarding whether to accept the clothing consultant's suggestion or recommendation.

These teachings are readily implemented using existing technologies and, in many cases, can be readily implemented using legacy personally portable wireless two-way communicator platforms via supplemental programming. Accordingly, these teachings can be implemented in a highly economical manner and via a user interface with which many users are already quite familiar. Those skilled in the art will appreciate that these teachings can be implemented, in many cases, without requiring any additional equipment or facilities on the part of the parties offering such accessories, thereby further easing the path to implementation of such teachings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising: at a personally portable wireless two-way communicator:
providing an avatar as corresponds to a given object;
capturing an image as corresponds to an accessory for the given object;
using the image to determine metadata for the accessory;
using the metadata to determine a virtual visual rendering of the accessory;
visually displaying the avatar in combination with the virtual visual rendering of the accessory to thereby provide an image that depicts how the given object and the accessory will appear in combination with one another.

2. The method of claim 1 wherein the given object comprises a human being and wherein the avatar is proportionally substantially identical to the human being.

3. The method of claim 2 wherein providing an avatar further comprises:
capturing an image of the human being;
providing a face for the avatar using the image of the human being.

4. The method of claim 2 wherein providing an avatar further comprises:
receiving input from a user of the personally portable wireless two-way communicator regarding external measurements of the user;
using the external measurements of the user to determine an appearance of the avatar that graphically represents the user.

5. The method of claim 2 wherein providing an avatar further comprises:
projecting a comparative image that has a standard external measurement towards a user of the personally portable wireless two-way communicator;
capturing an image of the user in combination with the comparative image;
processing the image to compare the user to the comparative image to thereby provide comparative information;
using the comparative information to determine external measurements and an appearance of the avatar.

6. The method of claim 2 wherein the accessory comprises at least one article of clothing.

7. The method of claim 1 wherein capturing an image as corresponds to an accessory for the given object comprises capturing an image of an optical code.

8. The method of claim 1 wherein the metadata comprises, at least in part, at least one of:
at least one linear measurement;
information regarding color;
information regarding an external pattern;
information regarding an external texture;
information regarding a size of at least a portion of the accessory.

9. The method of claim 1 wherein providing an avatar as corresponds to a given object comprises, at least in part, at least one of:
providing an avatar of a user of the personally portable wireless two-way communicator;
providing an avatar of a third party to a user of the personally portable wireless two-way communicator.

10. The method of claim 9 wherein providing an avatar of a third party comprises, at least in part, receiving a wireless transmission of information that defines, at least in part, the avatar.

11. The method of claim 10 wherein receiving a wireless transmission of information that defines, at least in part, the avatar further comprises receiving a wireless transmission of encrypted information that defines, at least in part, the avatar.

12. The method of claim 11 wherein providing an avatar as corresponds to a given object further comprises using the encrypted information such that a user of the personally portable wireless two-way communicator cannot glean the third party avatar information itself in unencrypted form.

13. A personally portable wireless two-way communicator comprising;
a wireless transceiver;
a display;
an image capture device;
a memory having information regarding an avatar for a given object stored therein;
a processor operably coupled to the wireless transceiver, the display, the image capture device, and the memory, wherein the processor is configured and arranged to:
capture an image as corresponds to an accessory for the given object via the image capture device;
use the image to determine metadata for the accessory;
use the metadata to determine a virtual visual rendering of the accessory;
visually display the avatar on the display in combination with the virtual visual rendering of the accessory to thereby provide an image that depicts how the given object and the accessory will appear in combination with one another.

14. The personally portable wireless two-way communicator of claim 13 wherein the given object comprises a human being and wherein the avatar is proportionally substantially identical to the human being.

15. The personally portable wireless two-way communicator of claim 14 wherein the processor is further configured and arranged to provide an avatar by:
receiving input from a user of the personally portable wireless two-way communicator regarding external measurements of the user;
using the external measurements of the user to determine an appearance of the avatar that graphically represents the user.

16. The personally portable wireless two-way communicator of claim 14 wherein the accessory comprises at least one article of clothing.

17. The personally portable wireless two-way communicator of claim 13 wherein the image as corresponds to an accessory for the given object comprises an image of an optical code.

18. The personally portable wireless two-way communicator of claim 13 wherein the metadata comprises, at least in part, at least one of:
at least one linear measurement;
information regarding color;
information regarding an external pattern;
information regarding an external texture;
information regarding a size of at least a portion of the accessory.

19. The personally portable wireless two-way communicator of claim 13 wherein the avatar as corresponds to a given object comprises, at least in part, at least one of:
an avatar of a user of the personally portable wireless two-way communicator;
an avatar of a third party to a user of the personally portable wireless two-way communicator.

20. The personally portable wireless two-way communicator of claim 19 wherein the processor is further configured and arranged to receive a wireless transmission via the wireless transceiver of information that defines, at least in part, the avatar.
